(19) United States
(12) Patent Application Publication
(10) Pub. No.: US 2022/0380973 A1
(43) Pub. Date: Dec. 1, 2022

(54) Active ingredient preparation for a steam generator

(71) Applicant: Henkel AG & Co. KGaA, Duesseldorf (DE)

(72) Inventors: Walter HEBERLEIN, Wien (AT); Christian BRUECKMANN, Wien (AT); Frank PESSEL, Duesseldorf (DE); Ulrich PLATZBECKER, Duesseldorf (DE); Vera DIEL, Leverkusen (DE); Jens BODE, Meerbusch (DE)

(21) Appl. No.: 17/619,589

(22) PCT Filed: Jun. 9, 2020
(86) PCT No.: PCT/EP2020/065933

§ 371 Date: Dec. 16, 2021

(30) Foreign Application Priority Data
Jun. 17, 2019 (DE) 10 2019 116 408.7

(51) Int. Cl. D06M 13/53; D06M 13/00; D06M 23/10; D06M 23/06; D06M 11/79

(52) U.S. Cl. CPC D06M 13/53; D06M 13/005; D06M 23/10; D06M 23/06; D06M 11/79; D06M 2200/20; D06M 2200/12

(57) ABSTRACT

An active ingredient preparation may be used in steam generators that includes at least one specific carrier material and at least one specific active ingredient. The active ingredient preparation may be used together with steam for steaming textiles. A functional element for a hand-held steam generator for treating textiles may include the active ingredient preparation in or on a carrier element. Finally, a method for steaming textiles may include or consist of providing a steam generator having a functional element, generating steam in the steam generator, bringing the steam into contact with the active ingredient preparation, and then applying the steam, which contains the active ingredient preparation, to a textile to be steamed.

### CROSS-REFERENCE TO RELATED APPLICATIONS

The present application is a national stage entry according to 35 U. S.C. § 371 of PCT Application No. PCT/EP2020/065933 filed on Jun. 9, 2020; which claims priority to German Patent Application Serial No. 10 2019 116 408.7 filed on Jun. 17, 2019; all of which are incorporated herein by reference in their entirety and for all purposes.

### TECHNICAL FIELD

The present disclosure relates to an active ingredient preparation for use in steam generators that comprises at least one specific carrier material and at least one specific active ingredient. The present disclosure also relates to the use of the active ingredient preparation of the present disclosure together with steam for steaming textiles. The present disclosure further relates to a functional element for a hand-held steam generator for treating textiles, containing the active ingredient preparation according to the present disclosure in or on a carrier element. Finally, the present disclosure relates to a method for steaming textiles, comprising or consisting of the steps of: providing a steam generator which has a functional element of the present disclosure; generating steam in the steam generator; and bringing the steam into contact with the active ingredient preparation; and then applying the steam, which contains the active ingredient preparation or the at least one active ingredient, to a textile to be steamed.

### BACKGROUND

Steamers, steam brushes and steam irons are often used in the consumer sector to freshen up and smooth textiles. The devices are more manageable than the steam ironing systems and multi-functional finishers used in commercial use and work with lower steam pressures and temperatures.

Existing steam generators on the market use fully deionized or tap water to generate steam. This steam is used merely to smooth the textiles. However, in addition to smoothing the textiles, it would be desirable for said steam generators to be further functionalized. In particular, it would be desirable, for example, if removal of bad odors, an improved hygiene effect, a long-lasting fragrance experience, protection from insects and/or a water-repellent effect were achieved. Although there are already so-called ironing water products which are filled directly into the refill tank unit of the ironing system and used to generate steam, the effect of said products is usually not satisfactory since the active ingredients are thermally stressed due to the direct steam generation and are thus decomposed and lose their effect.

The problem to be solved is therefore that of providing an active ingredient preparation which is suitable for producing satisfactory effects on the steamed textiles which have been steamed with steam and the active ingredient preparation or the at least one active ingredient of the active ingredient preparation.

### SUMMARY

An active ingredient preparation for use in steam generators may include at least one carrier material and at least one active ingredient. The carrier material(s) may be or include, but are not limited to at least one solvent or at least one water-insoluble power or granular carrier material, and at least one active ingredient. The powder or granular carrier material may be or include silicon dioxide, silicic acids and derivatives thereof, clay, kaolin, bentonite, cellulose, plastics materials, zeolites, diatomaceous earth, or mixtures thereof. The active ingredient may be or include oxygen-based active substances, easy-ironing components, insect repellents, fragrances, bad odor-control compounds, antimicrobial agents, water repellents, surfactants, or mixtures thereof.

### BRIEF DESCRIPTION OF THE DRAWINGS

Embodiments will be explained in more detail below with reference to schematic drawings.

FIG. 1 shows a steam generator having a functional element according to a first embodiment.

FIG. 2 shows a side view of the steam generator according to FIG. 1.

FIG. 3 shows a further view of the steam generator according to FIG. 1.

FIG. 4 shows a steam generator having a functional element according to a second embodiment.

FIG. 5 shows a steam generator having a functional element according to a third embodiment.

FIG. 6 shows a steam generator having a functional element according to a fourth embodiment.

FIG. 7 shows a steam generator having a functional element according to a fifth embodiment.

FIG. 8 shows a steam generator having a functional element according to a first embodiment.

FIG. 9 shows a steam generator having a functional element according to a second embodiment.

FIG. 10 shows the steam generator according to FIG. 2 in a ready-to-use state.

FIG. 11 shows a steam generator having a functional element according to a third embodiment.

### DETAILED DESCRIPTION

“At least one,” as used herein, refers to 1 or more, for example 2, 3, 4, 5, 6, 7, 8, 9 or more. In connection with constituents of the compound described herein, this statement refers not to the absolute quantity of molecules, but rather to the type of component. “At least one surfactant” therefore signifies, for example, one or more different surfactants, i.e., one or more different types of surfactants.

All amounts stated in connection with the compositions described herein refer to wt. %, in each case based on the total weight of each component, unless stated otherwise. Moreover, amounts of this kind that refer to at least one constituent always refer to the total amount of this type of constituent contained in the active ingredient preparation, unless explicitly stated otherwise. That means that amounts of this kind, for example in the context of “at least one surfactant,” refer to the total amount of surfactants contained in each active ingredient preparation, unless explicitly stated otherwise.

Numbers stated herein with no decimal places refer to the full specified value with a decimal place. For example, “99%” stands for “99.0%.”

The terms “about” or “approximately” in connection with a numerical value refer to a variance of ±10%, preferably ±5%, particularly preferably ±1%, in relation to the specified numerical value.

Numerical ranges that are specified in the format “in/from x to y” include the stated values. If several preferred numerical ranges are indicated in this format, it is readily understood that all ranges that result from the combination of the various endpoints are also included.

Unless explicitly stated otherwise, if molecular masses or relative molecular masses or molar masses are described, the number average molecular weight MN, which can be determined by means of gel permeation chromatography using polystyrene standards, is used.

The term “substantially consisting of” is to be understood within the meaning of the present disclosure in such a way that the active ingredient preparation can have further compounds which are not mentioned as specific features, but these are so small in their proportion that they do not affect the technical properties of the active ingredient preparation. In particular, the active ingredient preparation can contain further compounds in amounts of up to 2 wt. %, preferably up to 1.0 wt. %, more preferably up to 0.1 wt. %, based on the total weight of the active ingredient preparation.

These and other aspects, features, and advantages will become apparent to a person skilled in the art through the study of the following detailed description and claims. Any feature from one aspect can be used in any other aspect. Furthermore, it will readily be understood that the examples contained herein are intended to describe and illustrate, but not to limit, the invention and that, in particular, the invention is not limited to these examples.

In a first aspect, the present disclosure relates to an active ingredient preparation for use in steam generators that comprises, substantially consists of or consists of:
A) at least one carrier material selected from
A1) at least one solvent or
A2) at least one water-insoluble powder or granular carrier material selected from silicon dioxide, silicic acids and derivatives thereof, clay, kaolin, bentonite, cellulose, plastics materials, zeolites, diatomaceous earth, or mixtures thereof; and
B) at least one active ingredient selected from
B1) oxygen-based active substances,
B2) easy-ironing components,
B3) insect repellents,
B4) fragrances,
B5) bad odor-control compounds,
B6) antimicrobial agents,
B7) water repellents,
B8) surfactants, or mixtures thereof.

In a second aspect, the present disclosure relates to the use of the active ingredient preparation together with steam for steaming textiles.

In a third aspect, the present disclosure relates to a functional element for a hand-held steam generator for treating textiles, in particular items of clothing, containing the active ingredient preparation in or on a carrier element.

Finally, in a fourth aspect, the present disclosure relates to a method for steaming textiles, comprising or consisting of the steps of:

providing a steam generator which has a functional element; generating steam in the steam generator; and bringing the steam into contact with the active ingredient preparation; and then applying the steam, which contains the active ingredient preparation or the at least one active ingredient, to a textile to be steamed.

The active ingredient preparation for use in steam generators comprises, substantially consists of or consists of:
A) at least one carrier material selected from
A1) at least one solvent or
A2) at least one water-insoluble powder or granular carrier material selected from silicon dioxide, silicic acids and derivatives thereof, clay, kaolin, bentonite, cellulose, plastics materials, zeolites, diatomaceous earth, or mixtures thereof and
B) at least one active ingredient selected from
B1) oxygen-based active substances,
B2) easy-ironing components,
B3) insect repellents,
B4) fragrances,
B5) bad odor-control compounds,
B6) antimicrobial agents,
B7) water repellents,
B8) surfactants, or mixtures thereof.

In various embodiments, the at least one carrier material A) to the at least one active ingredient B) is present in a weight ratio of from 99:1 to 80:15.

In various embodiments, the at least one carrier material is at least one solvent. Suitable solvents are water and organic solvents, as well as mixtures thereof. Organic solvents are preferably selected from alcohols, ethers and aromatic organic solvents. In particular, alcohols are preferred. Examples include methanol, ethanol, propanol, isopropanol, butanol and pentanol. Ethanol is particularly preferred. In various embodiments, a mixture of water and at least one organic solvent, in particular alcohols, particularly preferably ethanol, is present. In preferred embodiments, the proportion by weight of water to organic solvent, preferably alcohol, in particular ethanol, is from 99:1 up to 50:50, in particular 99:1 up to 90:10.

In various embodiments, the at least one carrier material is a water-insoluble powder or granular carrier material selected from silicon dioxide, silicic acids and derivatives thereof, clay, kaolin, bentonite, cellulose, plastics materials, zeolites, diatomaceous earth, or mixtures thereof. In preferred embodiments it is selected from silicon dioxide, silicic acids and derivatives thereof, clay, kaolin, bentonite, or mixtures thereof. More preferably it is a silicic acid or a derivative thereof. Within the meaning of the present disclosure, derivatives of silicic acids are modified silicic acids, for example pyrogenic silicic acid. Pyrogenic silicic acid is synthetic quartz glass which is produced by pyrolysis of silicon tetrachloride or vaporized quartz in order to form tiny droplets of amorphous quartz glass which fuse into an articulated particle structure.

Furthermore, the active ingredient preparation contains at least one active ingredient.

In various embodiments, said preparation comprises at least one oxygen-based active substance. Preferred oxygen-based active substances comprise peroxide compounds and (di)carboxylic acids and the salts thereof.

Suitable (di)carboxylic acids are, for example, adipic acid, succinic acid and glutaric acid, in particular the Na salts thereof, as well as citric acid, malic acid, acetic acid and lactic acid. Citric acid is particularly preferred.

Suitable peroxide compounds may be in particular organic peracids or peracid salts of organic acids, such as phthalimidopercaproic acid, perbenzoic acid, monoperoxyphthalic acid, and diperdodecane diacid and salts thereof, such as magnesium monoperoxyphthalate, diacyl peroxides, hydrogen peroxide and inorganic salts which release hydrogen peroxide under the conditions of use, such as alkali perborate, alkali percarbonate and/or alkali persilicate, and hydrogen peroxide inclusion compounds, such as H202 urea adducts, and mixtures thereof.

In various embodiments, the at least one oxygen-based active substance is contained from 0 to 10 wt. %, preferably 0.001 to 5 wt. %, more preferably from 0.1 to 1 wt. %.

In various embodiments, the at least one active ingredient comprises at least one easy-ironing component. Within the meaning of the disclosure, easy-ironing components are understood to mean substances which, by acting on textile fabrics, ensure that the textiles have a low frictional resistance during ironing. The following silicone oils having formulas I to III have proven to be particularly suitable easy-ironing components.

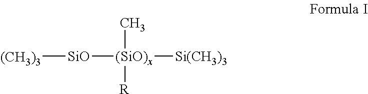

where R=phenyl or C1-C5 alkyl, particularly preferably methyl, and x=5 to 100,000.

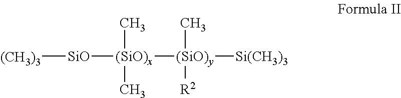

where R²=linear or branched alkyl having 6 to 50 carbon atoms and where the linkage with the Si atom is made via an Si—O—C bond or an Si—C bond, or a linear or branched aminoalkyl functional group where x=0 to 10,000 and y=1 to 10,000.

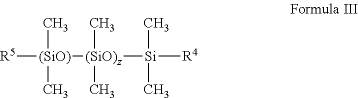

where R⁴ and R⁵ represent, independently of one another, linear or branched alkyl groups having 6 to 50 carbon atoms. The links to the Si atoms are made via C—Si or C—O—Si bonds. The number z is between 1 and 10,000.

Partially oxidized polyethylenes are further easy-ironing components.

Partially oxidized polyethylene is to be understood as meaning predominantly linear polyethylene waxes which are products having relatively low weight-average molar masses in the range of from 500 to 50,000 g/mol. The polyethylene waxes are generally produced by means of direct low-pressure polymerization or, preferably, high-pressure polymerization of the monomers or by means of targeted depolymerization of products of higher molar masses. The modified polyethylene waxes used here can be prepared by means of polymerization of ethylene, preferably in the absence of a catalyst with premature termination of the polymerization, and subsequent oxidation, for example by introducing air, or by means of copolymerization of ethylene together with other suitable monomers such as acrylic acid, the proportion of acrylic acid units preferably not exceeding 20%, in particular 10%. Finally, it is possible to improve the dispersibility of polyolefins by means of oxidative surface treatment. Overviews on this topic can be found, for example, in Ullmann's Encyclopedia of Technical Chemistry, 4. Ed., 24, 36 and in Encycl. Polym. Sci. Eng. 17, 792f.

In various embodiments, the at least one easy-ironing component is contained from 0 to 30 wt. %, preferably 0.1 to 20 wt. %, more preferably 1.0 to 5 wt. %.

In various embodiments, the at least one active ingredient comprises at least one insect repellent. According to a non-limiting embodiment, all known insect repellents are generally suitable. These are preferably selected from permethrin, allethrin, deltamethrin, cyfluthrin, cyhalothrin, cypermethrin, saltidin, diethyltoluamide, N-butylacetanilide, di-n-propylisocinchomeronate, indalone, sigillins, (1S,2′S)-methylpiperidinyl-3-cyclohexene-1-carboxamide, 2-butyl-2-ethyl-1,3-propanediol, ethyl butyl acetyl aminopropionate, or mixtures thereof.

Permethrin, saltidin, and mixtures thereof are particularly preferred.

In various embodiments, the at least one insect repellent is contained from 0 to 15 wt. %, preferably 0.001 to 10 wt. %, more preferably 0.1 to 2 wt. %.

In various embodiments, the at least one active ingredient comprises at least one fragrance.

The odor of a fragrance is perceived by most people as pleasant and often corresponds to the smell of, for example, flowers, fruits, spices, bark, resin, leaves, grasses, mosses and roots. Fragrances can thus also be used to overlay unpleasant odors or even to provide a non-smelling substance with a desired odor. It is possible, for example, to use individual odorant compounds, such as synthetic products of the ester, ether, aldehyde, ketone, alcohol and hydrocarbon types, as fragrances.

Fragrance compounds of the aldehyde type are, for example, adoxal (2,6,10-trimethyl-9-undecenal), anisaldehyde (4-methoxybenzaldehyde), cymene (3-(4-isopropyl-phenyl)-2-methylpropanal), ethylvanillin, Florhydral (3-(3-isopropylphenyl)butanal), Helional (3-(3,4-methylenedioxyphenyl)-2-methylpropanal), heliotropin, hydroxycitronellal, lauraldehyde, Lyral (3- and 4-(4-hydroxy-4-methylpentyl)-3-cyclohexene-1-carboxaldehyde), methylnonylacetaldehyde, Lilial (3-(4-tert-butylphenyl)-2-methylpropanal), phenyl acetaldehyde, undecylenealdehyde, vanillin, 2,6,10-trimethyl-9-undecenal, 3-dodecen-1-al, alpha-n-amyl cinnamaldehyde, melonal (2,6-dimethyl-5-heptenal), 2,4-di-methyl-3-cyclohexene-1-carboxaldehyde (Triplal), 4-methoxybenzaldehyde, benzaldehyde, 3-(4-tert-butylphenyl)-propanal, 2-methyl-3-(para-methoxyphenyl)propanal, 2-methyl-4-(2,6,6-timethyl-2(1)-cyclohexen-1-yl)butanal, 3-phenyl-2-propenal, cis-/trans-3,7-dimethyl-2,6-octadien-1-al, 3,7-dimethyl-6-octen-1 -al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl)propanal, 1-decanal, 2,6-dimethyl-5-heptenal, 4-(tricyclo[5.2.1.0(2,6)]-decylidene-8)-butanal, octahydro-4J-methane-1H-indenecarboxaldehyde, 3-ethoxy-4-hydroxybenzaldehyde, para-ethyl-alpha, alpha-dimethylhydrocinnamaldehyde, alpha-methyl-3,4-(methylenedioxy)-hydrocinnamaldehyde, 3,4-methylenedioxybenzaldehyde, alpha-n-hexylcinnamaldehyde, m-cymene-7-carboxaldehyde, alpha-methylphenylacetaldehyde, 7-hydroxy-3J-dimethyloctanal, undecenal, 2,4,6-trimethyl-3-cyclohexene-1-carboxaldehyde, 4-(3)(4-methyl-3-pentenyl)-3-cyclohexene carboxaldehyde, 1-dodecanal, 2,4-dimethylcyclohexene-3-carboxaldehyde, 4-(4-hydroxy-4-methylpentyl)-3-cyclohexene-1-carboxaldehyde, 7-methoxy-3,7-dimethyloctan-1-al, 2-methyl-undecanal, 2-methyldecanal, 1-nonanal, 1-octanal, 2,6,10-trimethyl-5,9-undecadienal, 2-methyl -3-(4-tert-butyl)propanal, dihydrocinnamaldehyde, 1-methyl-4-(4-methyl-3-pentenyl)-3-cyclohexene-1-carboxaldehyde, 5- or 6-methoxyhexahydro-4,7-methanindan-1- or 2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3J-dimethyl -octanal, trans-4-decenal, 2,6-nonadienal, para-tolylacetaldehyde, 4-methylphenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexene-carboxaldehyde, 3J-dimethyl-2-methylene-6-octenal, phenoxyacetaldehyde, 5,9-dimethyl-4,8-decadienal, peonyaldehyde (6,10-dimethyl-3-oxa-5,9-undecadien-1-al), hexahydro-4,7-methanindan-1-carboxaldehyde, 2-methyloctanal, alpha-methyl-4-(1-methylethyl)benzeneacetaldehyde, 6,6-dimethyl-2-norpinene-2-propionaldehyde, para-methylphenoxyacetaldehyde, 2-methyl-3-phenyl -2-propen-1-al, 3,5,5-trimethylhexanal, hexahydro-8,8-dimethyl-2-naphthaldehyde, 3-propyl-bicyclo-[2.2.1]-hept-5-ene-2-carbaldehyde, 9-decenal, 3-methyl-5-phenyl-1-pentanal, methylnonylacetaldehyde, hexanal and trans-2-hexenal.

Fragrance compounds of the ketone type are, for example, methyl-beta-naphthyl ketone, musk indanone (1,2,3,5,6,7-hexahydro-1,1,2,3,3-pentamethyl-4H-inden-4-one), tonalide (6-acetyl-1,1,2,4,4,7-hexamethyltetralin), alpha-damascone, beta-damascone, delta-damascone, iso-damascone, damascenone, methyl dihydrojasmonate, menthone, carvone, camphor, Koavone (3,4,5,6,6-pentamethylhept-3-en-2-one), fenchone, alpha-ionone, beta-ionone, gamma-methyl-ionone, fleuramone (2-heptylcyclopentanone), dihydrojasmone, cis-jasmone, iso E Super (1-(1,2,3,4,5,6J,8-octahydro-2,3,8,8-tetramethyl-2-naphthalenyl)-ethan-1-one (and isomers)), methyl cedrenyl ketone, acetophenone, methyl acetophenone, para-methoxy acetophenone, methyl beta-naphthyl ketone, benzyl acetone, benzophenone, para-hydroxyphenyl butanone, celery ketone (3-methyl-5-propyl-2-cyclohexenone), 6-isopropyl decahydro-2-naphthone, dimethyloctenone, Frescomenthe (2-butan-2-yl-cyclohexan-1-one), 4-(1-ethoxyvinyl)-3,3,5,5-tetramethylcyclohexanone, methylheptenone, 2-(2-(4-methyl-3-cyclohexen-1-yl)propyl)cyclopentanone, 1-(p-menthen-6(2)yl)-1-propanone, 4-(4-hydroxy-3-methoxyphenyl)-2-butanone, 2-acetyl-3,3-dimethylnorbornane, 6,7-dihydro-1,1,2,3,3-pentamethyl-4(5H)-indanone, 4-damascol, Dulcinyl (4-(1,3-benzodioxol-5-yl)butan-2-one), hexalone (1-(2,6,6-trimethyl-2-cyclohexen-1-yl)-1,6-heptadien-3-one), isocyclemoneE(2-acetonaphthone-1,2,3,4,5,6,7,8-octahydro-2,3,8,8-tetramethyl), methyl nonyl ketone, methyl cyclocitrone, methyl lavender ketone, orivone (4-tert-amylcyclohexanone), 4-tert-butylcyclohexanone, delphone (2-pentyl-cyclopentanone), muscone (CAS 541-91-3), neobutenone (1-(5,5-dimethyl-1-cyclohexenyl)pent-4-en-1-one), plicatone (CAS 41724-19-0), veloutone (2,2,5-trimethyl-5-pentylcyclopentan--one), 2,4,4,7-tetramethyl-oct-6-en-3-one and tetrameran (6,10-dimethylundecen-2-one).

Fragrance compounds of the alcohol type are, for example, 10-undecen-1-ol, 2,6-dimethylheptan-2-ol, 2-methylbutanol, 2-methylpentanol, 2-phenoxyethanol, 2-phenylpropanol, 2-tert-butycyclohexanol, 3,5,5-trimethyl cycl ohexanol, 3-hexanol, 3-methyl-5-phenylpentanol, 3-octanol, 3-phenyl-propanol, 4-heptenol, 4-isopropylcyclohexanol, 4-tert-butycyclohexanol, 6,8-dimethyl-2-nonanol, 6-nonen-1-ol, 9-decen-1-ol, α-methylbenzyl alcohol, α-terpineol, amyl salicylate, benzyl alcohol, benzyl salicylate, (β-terpineol, butyl salicylate, citronellol, cyclohexyl salicylate, decanol, dihydromyrcenol, dimethyl benzyl carbinol, dimethyl heptanol, dimethyl octanol, ethyl salicylate, ethyl vanillin, eugenol, farnesol, geraniol, heptanol, hexyl salicylate, isoborneol, isoeugenol, isopulegol, linalool, menthol, myrtenol, n-hexanol, nerol, nonanol, octanol, p-menthan-7-ol, phenyl ethyl alcohol, phenol, phenyl salicylate, tetrahydrogeraniol, tetrahydrolinalool, thymol, trans-2-cis-6-nonadi cnol, trans-2-nonen-1-ol, trans-2-octenol, undecanol, vanillin, champiniol, hexenol and cinnamyl alcohol.

Fragrance compounds of the ester type are, for example, benzyl acetate, phenoxyethyl isobutyrate, p-tert-butylcyclohexyl acetate, linalyl acetate, dimethylbenzylcarbinyl acetate (DMBCA), phenylethyl acetate, benzyl acetate, ethylmethylphenyl glycinate, allylcyclohexyl propionate, styrallyl propionate, benzyl salicylate, cyclohexyl salicylate, floramate, melusate, and jasmacyclate.

Ethers include, for example, benzyl ethyl ether and Ambroxan. Hydrocarbons mainly include terpenes such as limonene and pinene.

Preferably, mixtures of different fragrances are used, which together produce an appealing fragrance note. Such a mixture of fragrances may also be referred to as perfume or perfume oil. Perfume oils of this kind may also contain natural fragrance mixtures, such as those obtainable from plant sources.

Fragrances of plant origin include essential oils, such as angelica root oil, aniseed oil, arnica blossom oil, basil oil, bay oil, champaca blossom oil, citrus oil, abies alba oil, abies alba cone oil, elemi oil, eucalyptus oil, fennel oil, spruce needle oil, galbanum oil, geranium oil, ginger grass oil, guaiac wood oil, gurjun balsam oil, helichrysum oil, ho oil, ginger oil, iris oil, jasmine oil, cajeput oil, calamus oil, chamomile oil, camphor oil, cananga oil, cardamom oil, cassia oil, pine needle oil, copaiba balsam oil, coriander oil, spearmint oil, caraway oil, cumin oil, labdanum oil, lavender oil, lemon grass oil, lime blossom oil, lime oil, mandarin oil, melissa oil, mint oil, musk seed oil, muscatel oil, myrrh oil, clove oil, neroli oil, niaouli oil, olibanum oil, orange blossom oil, orange peel oil, oregano oil, palmarosa oil, patchouli oil, balsam Peru oil, petitgrain oil, pepper oil, peppermint oil, allspice oil, pine oil, rose oil, rosemary oil, sage oil, sandalwood oil, celery oil, spike lavender oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil, and ambrettolide, Ambroxan, alpha-amylcinnamaldehyde, anethole, anisaldehyde, anise alcohol, anisole, anthranilic acid methyl ester, acetophenone, benzylacetone, benzaldehyde, benzoic acid ethyl ester, benzophenone, benzyl alcohol, benzyl acetate, benzyl benzoate, benzyl formate, benzyl valerianate, borneol, bornyl acetate, boisambrene forte, alpha-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptyne carboxylic acid methyl ester, heptaldehyde, hydroquinone dimethyl ether, hydroxycinnamaldehyde, hydroxycinnamyl alcohol, indole, irone, isoeugenol, isoeugenol methyl ether, isosafrole, jasmine, camphor, carvacrol, carvone, p-cresol methyl ether, coumarin, p-methoxyacetophenone, methyl n-amyl ketone, methylanthranilic acid methyl ester, p-methylacetophenone, methylchavicol, p-methyl quinoline, methyl beta-naphthyl ketone, methyl n-nonylacetaldehyde, methyl n-nonyl ketone, muscone, beta-naphthol ethyl ether, beta-naphthol methyl ether, nerol, n-nonylaldehyde, nonyl alcohol, n-octylaldehyde, p-oxy-acetophenone, pentadecanolide, beta-phenethyl alcohol, phenylacetic acid, pulegone, safrole, salicylic acid isoamyl ester, salicylic acid methyl ester, salicylic acid hexyl ester, salicylic acid cyclohexyl ester, santalol, sandelice, skatole, terpineol, thyme, thymol, troenan, gamma-undecalactone, vanillin, veratraldehyde, cinnamaldehyde, cinnamyl alcohol, cinnamic acid, cinnamic acid ethyl ester, cinnamic acid benzyl ester, diphenyl oxide, limonene, linalool, linalyl acetate and propionate, melusate, menthol, menthone, methyl-n-heptenone, pinene, phenylacetaldehyde, terpinyl acetate, citral, citronellal and mixtures thereof.

The at least one fragrance can also be present as a fragrance precursor compound or encapsulated, in particular in microcapsules. These are known to a person skilled in the art in the field of fragrances.

In various embodiments, the at least one fragrance is contained from 0 to 30 wt. %, preferably 1 to 20 wt. %, more preferably 5 to 15 wt. %.

In various embodiments, the at least one active ingredient comprises at least one bad odor-control compound. Bad odor-control compounds are also known to a person skilled in the art under the term malodor control agents. These compounds are able to bind a bad odor and “neutralize” its odor. Suitable bad odor-control compounds are preferably selected from citronellyl methyl crotonate, cyclodextrins, activated carbon, chlorophyll, copper chlorophyll, zinc ricinoleate, oxazolidines and derivatives thereof, silicic acid esters, farnesol, or mixtures thereof. These oxazolidines, zinc ricinoleate, or mixtures thereof are preferred.

Suitable oxazolidines and their derivatives are described, for example, in DE 10 2011081871 A1 or DE 10 2006 003 092 A1.

In various embodiments, the at least one bad odor-control compound is contained from 0 to 10 wt. %, preferably 0.001 to 5 wt. %, more preferably 0.1 to 2 wt. %.

In various embodiments, the at least one active ingredient comprises at least one antimicrobial agent.

Antimicrobial agents are known to the person skilled in the art and include b acterostats, antiviral s, fungi stats, algi statics, virucides, bactericides, fungicides and algicides. In various embodiments, these are antimicrobial agents selected from iodopropynylbutyl carbamate, N-dichlorofluoromethylthio-N,N-dimethyl-N-phenylsulphamide, tetrachlorophthalonitrile, 2-methoxycarbonylaminobenzimidazole, trichloromethylthiophthalimide, and isothiazolinone compounds such as 2-n-octyl-3(2H)-isothiazolinone, benzisothiazolone and/or a mixture of 2-meth 4-isothiazolinone and 5-chloro-2-methyl-4-isothiazolinone. Benzisothiazolinone is particularly preferred.

In various embodiments, the at least one antimicrobial agent is contained from 0 to 10 wt. %, preferably 0.001 to 5 wt. %, more preferably 0.1 to 2 wt. %.

In various embodiments, the at least one active ingredient comprises at least one water repellent.

Suitable water repellents are, for example, silicone-containing impregnating agents that advantageously contain various polysiloxanes having condensable groups which advantageously make them more or less water-repellent.

Alternative water repellents are paraffins, waxes, metal soaps (sometimes also with additives of aluminum or zirconium salts), quaternary ammonium compounds having long-chain alkyl functional groups, urea derivatives, fatty acid-modified melamine resins, chromium complex salts, organic tin compounds and/or glutaraldehyde.

In various embodiments, the at least one water repellent is contained from 0 to 30 wt. %, preferably 0.1 to 20 wt. %, more preferably 1.0 to 5 wt. %.

In various embodiments, the at least one active ingredient comprises at least one surfactant.

This can be at least one non-ionic, anionic, zwitterionic or cationic surfactant, or mixtures thereof. Non-ionic and anionic surfactants, and mixtures thereof, in particular non-ionic surfactants, are preferred.

In one embodiment, the at least one non-ionic surfactant is selected from alkoxylated fatty acid alkyl esters, polyhydroxy fatty acid amides, alkyl glycosides and alkoxylated alcohols and mixtures thereof

Another class of preferably used non-ionic surfactants are alkoxylated, preferably ethoxylated or ethoxylated and propoxylated fatty acid alkyl esters, preferably having 1 to 4 carbon atoms in the alkyl chain.

Other suitable surfactants are the polyhydroxy fatty acid amides that are known as PHFAs.

Alkyl glycosides of general formula RO(G)x are also suitable, for example, where R corresponds to a primary straight-chain or methyl-branched aliphatic functional group, in particular an aliphatic functional group that is methyl-branched in the 2 position and has 8 to 22, preferably 12 to 18, C atoms, and G is the symbol that represents a glycose unit having 5 or 6 C atoms, preferably glucose. The degree of oligomerization x, which indicates the distribution of monoglycosides and oligoglycosides, is any number between 1 and 10; x is preferably between 1.2 and 1.4.

In one embodiment, the non-ionic surfactants are selected from the group of alkoxylated alcohols. Non-ionic surfactants that are preferably used are alkoxylated, advantageously ethoxylated, in particular primary alcohols having preferably 8 to 18 C atoms and, on average, 1 to 12 mol ethylene oxide (EO) or propylene oxide (PO) per mol of alcohol and in which the alcohol functional group can be linear or preferably methyl-branched in the 2 position, or can contain linear and methyl-branched functional groups in admixture, as are usually present in oxo alcohol functional groups. However, alcohol ethoxylates having linear functional groups of alcohols of native origin having 12 to 18 C atoms, for example from coconut, palm, tallow fatty or oleyl alcohol, and an average of 2 to 8 EO per mol of alcohol, are particularly preferred. Preferred ethoxylated alcohols include, for example, C12-14 alcohols having 3 EO or 4 EO, C8-11 alcohols having 7 EO, C13-15 alcohols having 3 EO, 5 EO, 7 EO or 8 EO, C12-18 alcohols having 3 EO, 5 EO or 7 EO, and mixtures thereof, such as mixtures of C12-14 alcohol having 3 EO and C12-18 alcohol having 5 EO. C12-18 alcohols having 7 EO are particularly preferred.

In various embodiments, the at least one surfactant is contained from 0 to 50 wt. %, preferably 1 to 30 wt. %, more preferably 5 to 20 wt. %.

In a preferred embodiment, the at least one carrier material is a water-insoluble powder or granular carrier material selected from silicon dioxide, silicic acids and derivatives thereof, clay, kaolin, bentonite, cellulose, plastics materials, zeolites, diatomaceous earth, or mixtures thereof, in particular silicic acids and derivatives thereof, particularly preferably pyrogenic silicic acid;
and/or
the at least one active ingredient comprises at least one fragrance;
and/or
the at least one active ingredient comprises at least one bad odor-control compound.

The at least one carrier material is particularly preferably a water-insoluble powder or granular carrier material selected from silicon dioxide, silicic acids and derivatives thereof, clay, kaolin, bentonite, cellulose, plastics materials, zeolites, diatomaceous earth, or mixtures thereof, in particular silicic acids and derivatives thereof, particularly preferably pyrogenic silicic acid;
the at least one active ingredient comprises at least one fragrance;
and
the at least one active ingredient comprises at least one bad odor-control compound.

In a preferred embodiment, the at least one carrier material is a solvent, preferably water and optionally an organic solvent, preferably an alcohol, in particular ethanol;
and/or
the at least one active ingredient comprises at least one oxygen-based active substance, in particular citric acid,
and/or
the at least one active ingredient comprises at least one fragrance;
and/or
the at least one active ingredient comprises at least one bad odor-control compound, preferably zinc ricinoleate;
and/or
the at least one active ingredient comprises at least one antimicrobial agent, in particular 1,2-benzisothiazol-3(2H)-one;
and/or
the at least one active ingredient comprises at least one surfactant, preferably a non-ionic surfactant, more preferably a fatty alcohol alkoxylate, most preferably a C12-18 fatty alcohol ethoxylate having 7 EO.

In a more preferred embodiment, the at least one carrier material is a solvent, preferably water and optionally an organic solvent, preferably an alcohol, in particular ethanol;
and
the at least one active ingredient comprises at least one oxygen-based active substance, in particular citric acid,
and
the at least one active ingredient comprises at least one fragrance;
and the at least one active ingredient comprises at least one bad odor-control compound, preferably zinc ricinoleate;
and
the at least one active ingredient comprises at least one antimicrobial agent, in particular 1,2-benzisothiazol-3(2H)-one;
and
the at least one active ingredient comprises at least one surfactant, preferably a non-ionic surfactant, more preferably a fatty alcohol alkoxylate, most preferably a C12-18 fatty alcohol ethoxylate having 7 EO.

The active ingredient preparation may be used together with steam for steaming textiles.

In addition, a functional element for a preferably hand-held steam generator for treating textiles, in particular items of clothing, may include the active ingredient preparation in or on a carrier element.

In the following, the active ingredient preparation is also referred to simply as an active ingredient preparation. If the active ingredient preparation includes at least one water-insoluble powder or granular carrier material as a carrier material, said carrier material is not released together with the steam, but only the at least one active ingredient contained therein. In the case of active ingredient preparations which are based on at least one solvent as a carrier material, the solvent having the at least one active ingredient is released together with the steam, i.e., the entire active ingredient preparation.

In the following, exemplary functional elements are described that can be used in/together with a steam generator known in the prior art. The exemplary embodiments describe the steaming of items of clothing. All types of textiles can be steamed. Consequently, in the embodiments described below, garments can be replaced by textiles; these embodiments are also specifically disclosed.

In one embodiment for a solvent-based active ingredient preparation, a functional element for a hand-held steam generator for treating items of clothing is specified that has a reservoir having an active ingredient preparation, as well as a device for generating a spray of an active ingredient preparation having an actuating device for releasing the spray. Furthermore, the functional element has at least one fastening device for fastening the functional element to a steam generator. The functional element can be positioned on the steam generator by means of the fastening device in such a way that a steam flow generated by the steam generator is mixed with the spray by the spray being discharged in the same direction as the steam from the steam generator. It is not necessary that the spray and steam are released at exactly the same time. A slight time delay between the release of the spray and the release of steam is also conceivable.

The functional element has the advantage that it provides steam to remove creases from an item of clothing, but by enriching the steam with at least one active ingredient, for example a fragrance, it allows the simultaneous removal of bad odors from the item of clothing. It is particularly advantageous that the active ingredient preparation is only mixed with the steam flow immediately before application to the item of clothing to be treated or that the active ingredient preparation is applied to the item of clothing to be treated in the form of a spray immediately before the steam is released. Thermal stress on the active ingredient preparation is therefore particularly low and active ingredients which are not thermally stable can advantageously also be used.

Since the steam emerges from the steam generator substantially at the same time as, or at least only with a slight time delay compared with, the active ingredient preparation, it is particularly easy for a user to use because it does not require any additional treatment steps. The active ingredient preparation is preferably released onto the item of clothing to be treated shortly before or at the same time as the steam.

According to one embodiment, the fastening device has at least one latching element for latching on the steam generator. For example, the functional element can be fastened to the steam generator by means of latching hooks or clips. Alternatively, however, force-fit connections such as clamps or form-fit connections such as screws are also conceivable.

This embodiment has the advantage that the functional element can be connected to the steam generator in a simple manner as required and can also be removed from it again.

It is therefore possible to use the functional element with a commercially available steam generator and to provide said element as an additional device for this steam generator.

According to one embodiment, the fastening device has a flat element for arrangement in the steam flow, wherein the flat element has a number of through-passages through which steam can flow and which form outlet openings for the steam, wherein the device for generating the spray is arranged in such a way that the spray is mixed with the steam flow in the flow direction behind the outlet openings. The spray and steam flow are aligned in the same way, so that, in addition to the simultaneous release of a spray-steam mixture, a slightly delayed independent release of spray and steam onto the item of clothing is possible.

Alternatively, the device for generating the spray can also be arranged in such a way that the spray is mixed with the steam flow in the flow direction in front of the outlet openings.

In order to achieve a good mixture of the spray with the steam, the spray direction is chosen such that the spray enters the emerging steam flow. Furthermore, steam guide structures can also be provided at the outlet openings for the steam, which structures give the emerging steam flow a direction that is favorable for mixing and/or specifically generate turbulence in order to achieve thorough mixing.

According to one embodiment, the functional element thus has steam guide structures in an outlet surface having the outlet openings. As already described, the steam guide structures have the task of promoting a mixture of the steam with the spray, but they can also be used to distribute the steam particularly well at the outlet surface so that the steam does not only come into contact with the textile to be treated at certain points, but also over a larger surface area and can therefore be particularly effective.

According to one embodiment, the reservoir for the active ingredient preparation is designed to be replaceable. In particular, it can be arranged such that it can be pulled off or twisted off and is arranged to be easily accessible for simple replacement.

This embodiment has the advantage that when the active ingredient preparation is used up, only the reservoir has to be replaced, and not the entire functional element.

As an alternative to this, the reservoir can also be designed to be refillable, which is particularly advantageous if the active ingredient preparation is held in the reservoir as a liquid. In this case, the reservoir can be refilled by a user in a simple manner.

Alternatively, the active ingredient preparation can also be held in the reservoir as an aerosol. In this case, easy refilling by a user is typically not provided for, but the emptied reservoir is replaced with a full one after the active ingredient preparation has been used up.

The actuating device for releasing the spray can be designed as a lever, button, switch or a similarly acting actuating element. For example, it can either be designed to exert a force on the reservoir or to open a valve on the reservoir.

The design of the actuating device for exerting a force on the reservoir is particularly advantageous when the active ingredient preparation in the reservoir is under ambient pressure and, for example, is liquid. As a result of the actuation, the reservoir can then be squeezed in such a way that the active ingredient preparation emerges at a device for generating a spray, for example at a nozzle.

The design of the actuating device for opening a valve on the reservoir can be advantageous if the active ingredient preparation in the reservoir is under increased pressure and emerges through a nozzle, for example, when the valve is opened.

These embodiments of the actuating device have the advantage that they are particularly robust and at the same time easy to operate. In particular, the design of the actuating device as a lever has the advantage that a user can hold an applicator of the steam generator, to which the functional element is attached, with the same hand and at the same time actuate the lever or the actuating element.

According to one embodiment, the functional element has steam guide structures in an outlet surface having the outlet openings. These can extend, for example, in the form of grooves or depressions starting from the outlet openings in the outlet surface in order not only to bring the emerging steam into contact with the item of clothing to be treated, but to distribute it in such a way that it is effective over the entire outlet surface.

According to one embodiment, the functional element has a display element for displaying consumption of the active ingredient preparation. This embodiment has the advantage that a user can easily see whether the active ingredient preparation has been used up and whether refilling or replacement of the carrier element is necessary. The display element can be, for example, a viewing window at which a fill level of the reservoir can be checked.

In an alternative embodiment, a functional element for a hand-held steam generator for treating items of clothing is specified, wherein the functional element has a carrier element provided with at least one active ingredient preparation and a receptacle for the at least one carrier element. The functional element also has at least one fastening device for fastening the functional element to the steam generator, wherein the functional element can be positioned on the steam generator by means of the fastening device in such a way that a steam flow generated by the steam generator is guided through the carrier element and is enriched with the active ingredient preparation or with the at least one active ingredient and emerges to the outside through outlet openings arranged in the functional element.

Here and below, a receptacle for the at least one carrier element is understood to mean a device in which the carrier element is held in a stable manner for use.

The steam flow emerging to the outside through outlet openings is understood to mean that the steam flow is brought into the region of a textile when the steam generator is in use. Here and in the following, “outside” thus refers to a region in which the steam can act on the treated item of clothing and is therefore no longer “inside” in the steam generator. If the steam flow accordingly emerges through the outlet openings, it can act directly on the treated item of clothing when the steam generator is used.

The functional element has the advantage that it provides steam to remove creases from an item of clothing, but by enriching the steam with at least one active ingredient, for example a fragrance, it allows the simultaneous removal of bad odors from the item of clothing. It is particularly advantageous that the active ingredient preparation is added to the steam flow only immediately before it emerges through the outlet openings. Thermal stress on the active ingredient preparation is therefore particularly low and active ingredients which are not thermally stable can advantageously also be used.

Since the steam emerges from the steam generator at the same time as the active ingredient preparation, it is particularly easy for a user to use because it does not require any additional steps.

According to one embodiment, the fastening device has at least one latching element for latching on the steam generator. For example, the functional element can be fastened to the steam generator by means of latching hooks or clips. Alternatively, however, force-fit connections such as clamps or form-fit connections such as screws are also conceivable.

This embodiment has the advantage that the functional element can be connected to the steam generator in a simple manner as required and can also be removed from it again.

It is therefore possible to use the functional element with a commercially available steam generator and to provide said element as an additional device for this steam generator.

According to one embodiment, the receptacle has a first flat element for arrangement in the steam flow and a second flat element for arrangement in the steam flow in the flow direction behind the first flat element, wherein the flat elements have a number of through-passages through which steam can flow. The carrier element can be arranged between the flat elements.

According to this embodiment, the carrier element, together with the first flat element and the second flat element of the receptacle, forms a type of sandwich through which steam can flow, wherein the steam is enriched with at least one active ingredient.

The flat elements can be connected to one another in an articulated manner. In this embodiment, they can be unfolded in order to insert the carrier element and folded up again for subsequent use, wherein the carrier element is held between the flat elements.

However, it is also conceivable to connect the flat elements to one another in some other way, for example by means of a latch.

According to one embodiment, the receptacle has a flat element which can be arranged in the steam flow and has at least one through-passage and an elastic element for fixing the carrier element in front of the at least one through-passage.

In this embodiment, the carrier element, which can be made flexible for example, is fixed by means of the elastic element, for example by means of a rubber band, in front of the at least one through-passage of the flat element in the steam flow. In this embodiment, the pores of the carrier element form the outlet openings of the functional element through which vapor enriched with at least one active ingredient emerges to the outside.

This embodiment has the advantage that it is particularly simple and has few parts.

According to one embodiment, the carrier element is formed from a textile fabric. In particular, the textile fabric can be woven, felted, knitted or crocheted. Such a textile fabric can be impregnated, soaked or wetted with the at least one active ingredient preparation, depending on the form in which the active ingredient preparation is present.

For example, the carrier element can be a felt fabric that has been soaked with the active ingredient preparation. In this embodiment, the at least one active ingredient then dissolves in the steam flow.

The textile fabric can, however, also be filled with the active ingredient preparation if the carrier material is at least one water-insoluble powder or granular specific carrier material.

In this embodiment, the textile fabric forms a type of pocket for the active ingredient preparation, the carrier material itself typically being insoluble and carrying the preferably water-soluble or volatile at least one active ingredient.

According to an alternative embodiment, the carrier element is designed as a porous solid body. In particular, it can be made of ceramic or plastics material and produced as a porous material by sintering, 3D printing or foaming.

For example, a method such as is known from DE 10 2016 217 303 A1 for 3D printing of filaments is suitable for producing the carrier element.

The porous solid body forming the carrier element is provided with the liquid active ingredient preparation or the active ingredient preparation which comprises at least one water-insoluble powder or granular specific carrier material as the carrier material. In particular, said solid body has an open-pore design and thus allows steam to flow through it, wherein said steam is enriched with the active ingredient preparation or the at least one active ingredient.

According to one embodiment, the carrier element is designed integrally with the receptacle and is designed as a textile fabric which can be placed in the steam flow. The fastening device is formed by regions of the textile fabric by the textile fabric being in the form of a tube which is closed at one end and can be pulled over a hand-held steam generator in such a way that the carrier element is placed in front of outlet openings of the steam generator.

In this embodiment, the fastening device is designed in that the tube is long enough to reach over the side regions of the hand-held steam generator and narrow enough not to slip off said steam generator during use.

The receptacle is designed as a front region at the closed end of the tube through the textile fabric, this region at the same time forming the carrier element and being provided with an active ingredient preparation, for example soaked, impregnated or wetted with said active ingredient preparation, or being held between two layers of the textile fabric as granules provided with the at least one active ingredient.

This embodiment has the advantage that it can be handled particularly easily and intuitively. In contrast to the other embodiments already described, the carrier element is not a component that is separate from the receptacle and the fastening device, but is made integrally with them.

According to one embodiment, the functional element has steam guide structures in an outlet surface having the outlet openings. These can extend, for example, in the form of grooves or depressions starting from the outlet openings in the outlet surface in order not only to bring the emerging steam into contact with the item of clothing to be treated, but to distribute it in such a way that it is effective over the entire outlet surface.

According to one embodiment, the functional element has a display element for displaying consumption of the active ingredient preparation. This embodiment has the advantage that a user can easily see whether the active ingredient preparation has been used up and whether refilling or replacement of the carrier element is necessary. The display element can in particular be a marking that changes its color or fades when the active ingredient preparation is used up. The display element can in particular be arranged on the carrier element.

The refilling of the active ingredient preparation can take place, depending on the carrier element used, by replacing the carrier element or by filling it up with the active ingredient preparation or the at least one active ingredient. For example, a textile pad can be used as the carrier element that is soaked with the active ingredient preparation and is completely replaced after the active ingredient preparation has been used up. However, a textile pad or a porous solid body can also be used as the carrier element, which pad or body is impregnated with a liquid active ingredient preparation, which can be refilled by the user when it is used up.

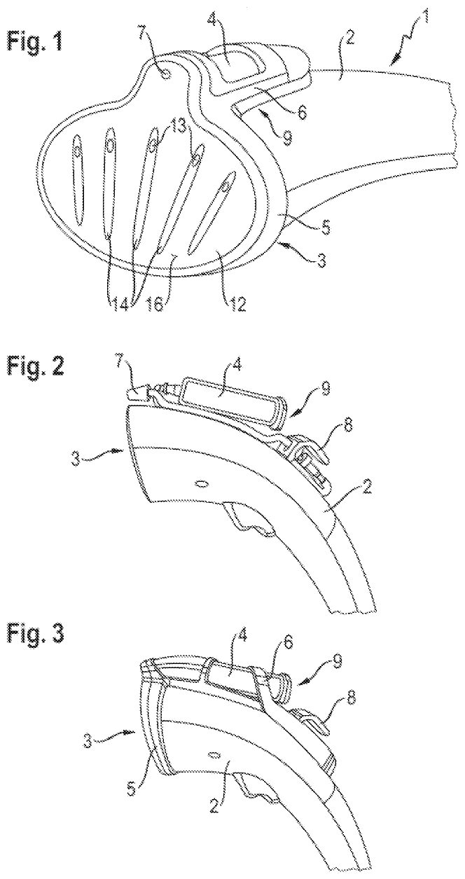

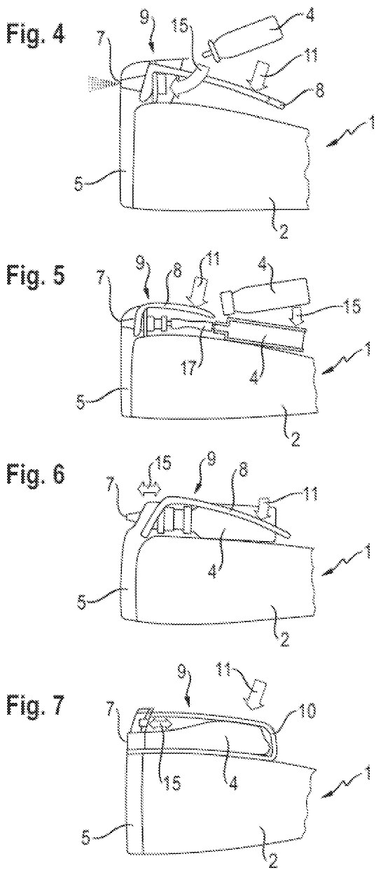

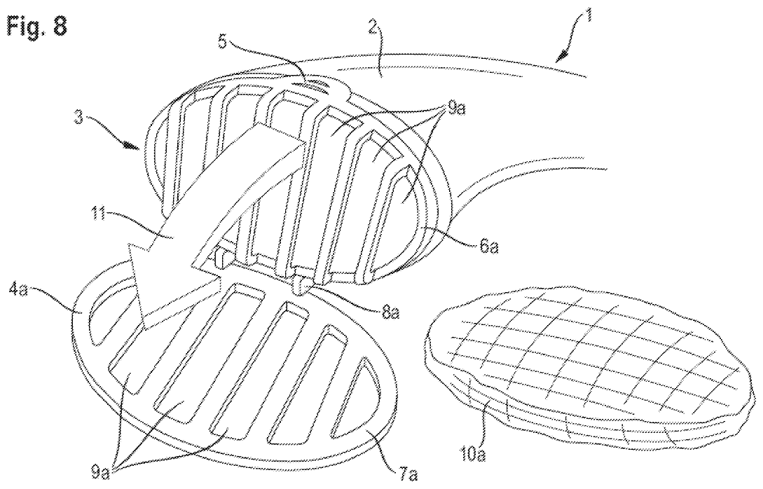

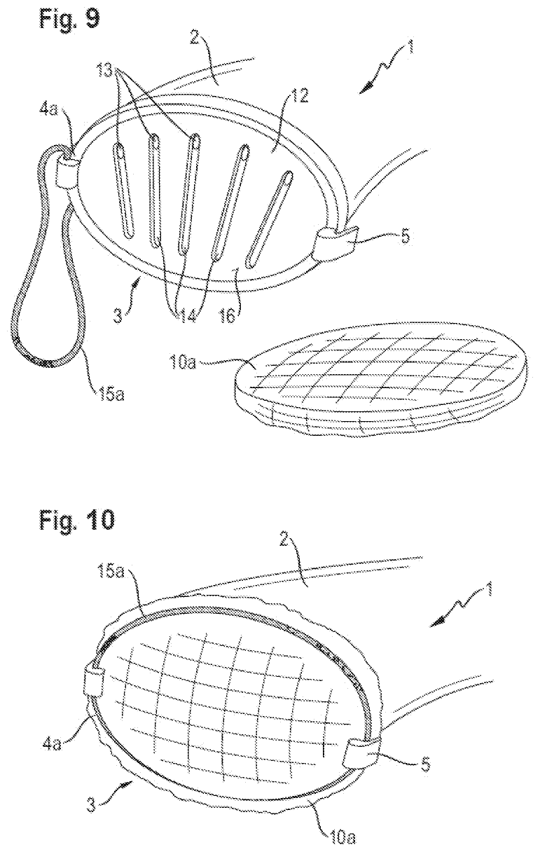

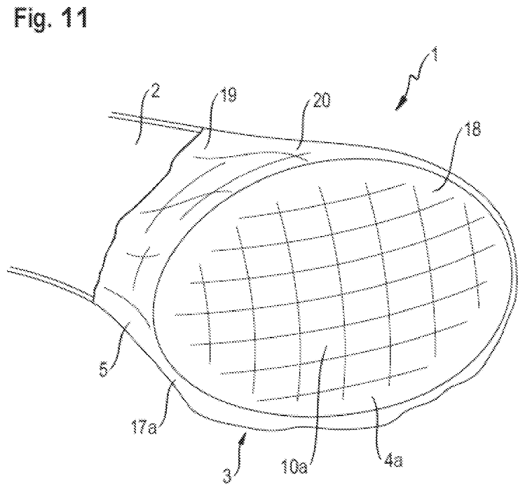

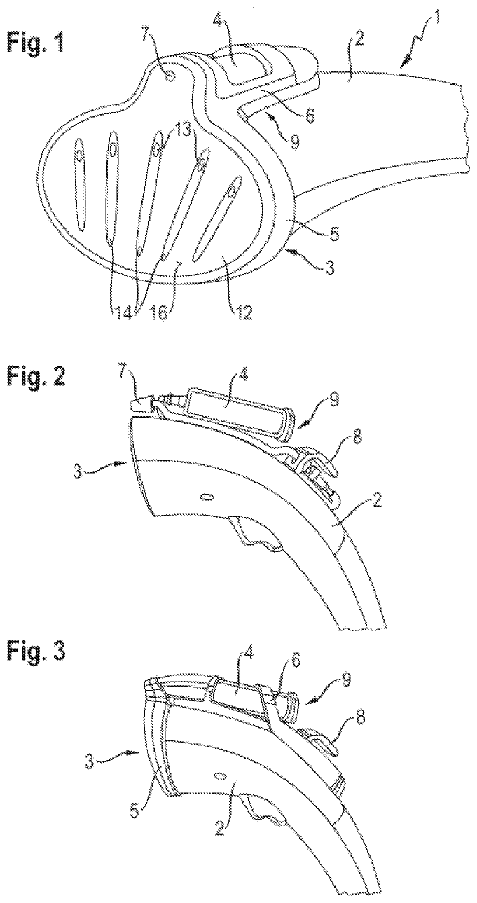

FIG. 1 schematically shows a hand-held steam generator 1 according to an embodiment. In the figure, only one applicator 2 of the steam generator 1 is shown, which applicator can be held by hand in order to apply steam to an item of clothing or another textile. However, the steam generator 1 also comprises further elements, in particular a water reservoir and a heating element.

A functional element 3 is preferably arranged on the applicator 2 in the region of the steam outlet and is fastened by means of a fastening device 5 which, in the embodiment shown, is designed as an edge that can be slipped over an edge of the applicator 2. Alternatively, the fastening device can, for example, have latching elements, for example latching hooks.

The functional element 3 has a flat element 12 which covers a steam outlet surface of the applicator 2. The flat element 12 has a number of through-passages 13 through which, during operation, steam can emerge to the outside from outlet openings of the applicator 2 that are arranged behind said through-passages and are not shown in the figure. Steam guide structures 14 in the surface 16 of the flat element 12 bring about a good distribution of the steam over the entire surface 16 and thus increase the effective area of the steam. In the embodiment shown, the vapor guide structures 14 are in the form of elongate depressions in the surface 16, each through-passage 13 being assigned such a depression and the depressions extending substantially over the entire surface 16.

The functional element 3 has a reservoir 4 having an active ingredient preparation which is suitable for generating a spray and can be present in the reservoir 4, for example, in liquid form or as an aerosol. To generate a spray, a device 9 is provided that comprises a holder 6 for receiving the reservoir 4 and a nozzle 7.

The device 9 is shown in more detail in FIGS. 2 and 3, parts of the holder 6 in particular being omitted in FIG. 2 for better understanding. In these figures it can be seen that the holder 6 is held on the applicator 2 by the fastening device 5 and forms a receptacle for the reservoir 4, which can be inserted into and removed from said receptacle.

When the reservoir 4 is inserted into the holder 6, a flow connection is established between the reservoir 4 and the nozzle 7 such that the active ingredient preparation can emerge through the nozzle 7. However, the device 9 can also comprise means for interrupting this flow connection, for example blocking elements or valves. As can be seen in FIGS. 2 and 3, the device 9 also comprises a lever 8 or some other suitable actuating element as an actuating device for releasing the spray, via which the flow connection can be opened if necessary.

In the embodiment shown in FIGS. 1 to 3, actuation of the lever 8 by pressing it in the direction of the applicator 2 generates a negative pressure in front of the reservoir, which allows the active ingredient preparation to emerge from the reservoir and pass through the nozzle 7 as a spray.

When it emerges from the nozzle 7, the spray mixes with the steam emerging from the through-passages 13 and thus enriches the steam with the active ingredient preparation.

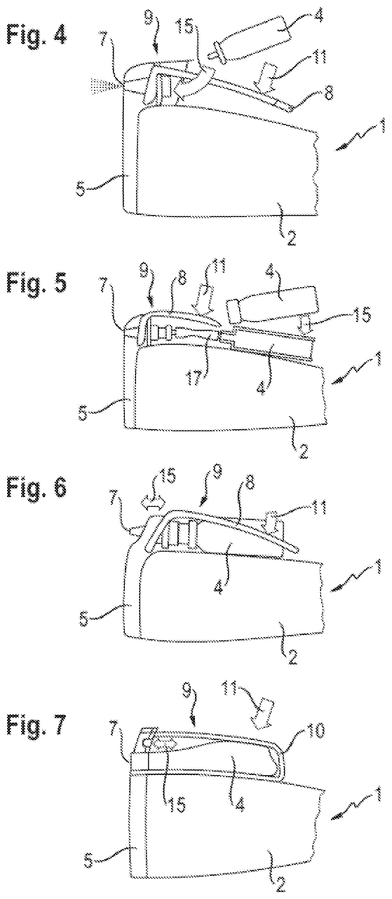

FIGS. 4 to 7 show further embodiments of the functional element 3, which differ from that shown in FIGS. 1 to 3 substantially only in the type of reservoir 4 and its connection.

FIG. 4 shows a reservoir 4 which contains an active ingredient preparation in the form of an aerosol, which is held in the reservoir 4 under pressure. The reservoir 4 is inserted into the device 9 and connected in the manner indicated by the arrow 15. When the lever 8 is pressed in the direction of the arrow 11, a connection to the nozzle 7 is opened and pressurized aerosol is released as a continuous spray through the nozzle 7. Once the reservoir 4 is empty, it can be removed and replaced with a full one.

Such a reservoir 4 has the advantage that it is particularly easy and particularly simple to replace and allows continuous spraying.

FIG. 5 shows a reservoir 4 which is designed as a container with a piston head which, when the reservoir 4 is emptied, slides into the container. This embodiment corresponds substantially to that shown in FIGS. 1 to 3. This reservoir 4 is also inserted or replaced in the manner indicated by the arrow 15 and connected to the nozzle 7 by means of a tube connection 17. By means of pressure on the lever 8 in the direction of the arrow 11, a negative pressure is generated in the tube connection 17 and the active ingredient preparation emerges from the reservoir 4 and through the nozzle 7.

Such a reservoir 4 has the advantage that it is particularly easy to replace, very robust and easy to seal.

FIG. 6 shows a reservoir 4 which is designed as a compressible container. This reservoir 4 is also inserted or replaced in the manner indicated by the arrow 15. By means of pressure on the lever 8 in the direction of the arrow 11, the reservoir 4 is squeezed and the active ingredient preparation is pressed out through the nozzle 7.

Such a reservoir 4 has the advantage that it is particularly easy to replace, very robust and easy to seal.

FIG. 7 shows a reservoir 4 which is designed as a bag having the active ingredient preparation arranged in a bellows 10. This reservoir 4 is also inserted or replaced in the manner indicated by the arrow 15. By means of pressure on the bellows 10 in the direction of the arrow 11, the reservoir 4 is squeezed and the active ingredient preparation is pressed out through the nozzle 7.

Such a reservoir 4 has the advantage that it can be fastened to the applicator 2 in a particularly simple and flexible manner.

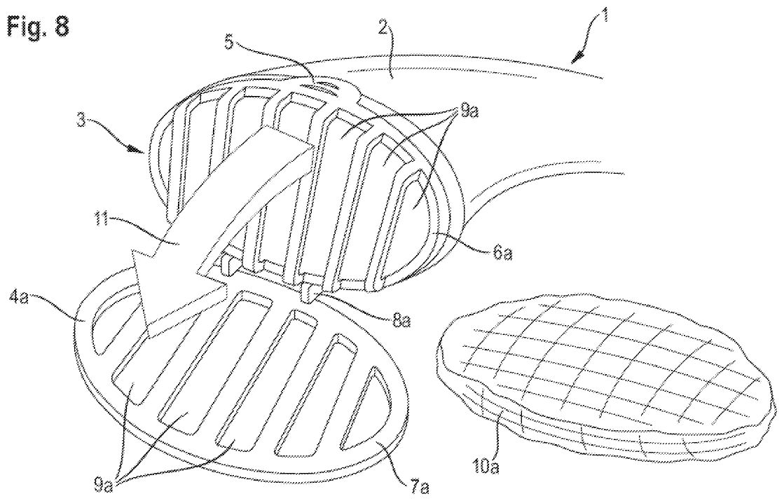

FIG. 8 schematically shows a hand-held steam generator 1 according to an embodiment. In the figure, only one applicator 2 of the steam generator 1 is shown, which applicator can be held by hand in order to apply steam to an item of clothing or another textile. However, the steam generator 1 also comprises further elements, in particular a water reservoir and a heating element.

A functional element 3 is arranged on the applicator 2 and fastened by means of a fastening device 5, which in the embodiment shown is designed as a latching hook and of which at least two are provided in the embodiment shown, but only one is shown in FIG. 8.

The functional element 3 has a receptacle 4a which comprises a first flat element 6a and a second flat element 7a which is connected to the first flat element 6a via a hinge 8a. Both elements 6a, 7a have a number of through-passages 9a which form outlet openings for steam and are arranged in front of outlet openings of the applicator 2, which are not shown in the figure.

The functional element 3 also has a carrier element 10a which is provided with an active ingredient preparation. In the embodiment shown in FIG. 8, the carrier element 10a is a pad made of a felt that is soaked with an active ingredient preparation containing fragrance.

The receptacle 4a can be opened by folding the second flat element 7a forward in the direction of the arrow 11 in order to receive the carrier element 10a between the flat elements 6a, 7a. The receptacle 4a is then closed again by folding the second flat element 7a in the opposite direction. The carrier element 10a is then between the two elements 6a, 7a.

The functional element 3 provided with the carrier element 10a in this way enriches the steam flow when the steam generator 1 is used, which steam flow emerges through the outlet openings of the applicator 2 and through-passages 9a in the first flat element 6a, passes through the carrier element 10a and comes into contact with the soaked-in active ingredient preparation, and then leaves the steam generator 1 again through the through-passages 9a in the second flat element 7a with the active ingredient preparation on.

In the embodiment shown, the active ingredient preparation contains a fragrance which therefore only comes into contact with the hot steam immediately before the steam is applied to the item of clothing and is therefore not exposed to any great thermal stress.

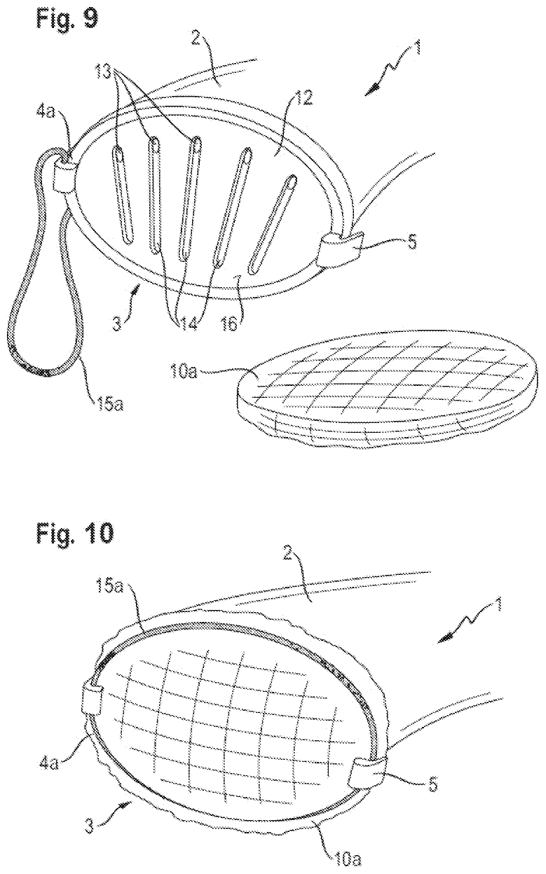

FIGS. 9 and 10 show a second embodiment of the functional element 3. This differs from that shown in FIG. 1 substantially in the design of the receptacle 4a. In the embodiment shown in FIGS. 2 and 3, the receptacle 4a has only one flat element 12, which can be fastened to the applicator 2 by means of a fastening device 5 comprising a plurality of elements and designed as a latching hook in the embodiment shown.

The flat element 12 has a number of through-passages 13 and also steam guide structures 14 connected to the through-passages 13. The steam guide structures 14 are designed as grooves in a surface 16 of the planar element 12. The steam guide structures 14, one of which is assigned to a through-passage 13, distribute steam emerging from the through-passages 13 over the surface 16 of the functional element 3.

The receptacle 4a further comprises a rubber band 15a, which can be stretched over an edge of the flat element 12 and thereby fastens a carrier element 10a in front of the surface 16.

FIG. 10 shows the functional element 3 according to FIG. 9 in the ready-to-use state in which the carrier element 10a is held in front of the surface 16 of the flat element 12 by means of the rubber band 15a. In this position, steam emerging from the through-passages 13 passes through the carrier element 10a and thereby comes into contact with the active ingredient preparation held on the carrier element 10a before it reaches the item of clothing to be treated.

Since the steam guide structures 14 distribute the steam over the entire surface 16, steam flows through practically the entire cross section of the carrier element 10a such that particularly good enrichment with at least one active ingredient is achieved.

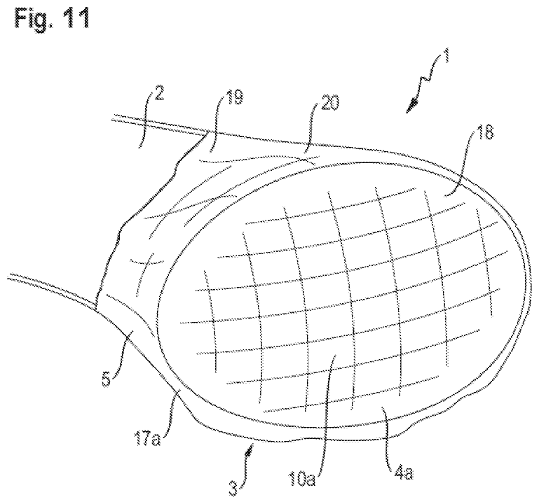

FIG. 11 shows a third embodiment of a functional element 3. According to this embodiment, the functional element has the form of a tube 17a which is closed at a first end 18 and made of a textile fabric. The second end 19 of the tube 17a is open. This hose 17a is pulled over the applicator 2 like a sock such that the closed first end 18, which forms the receptacle 4a and the carrier element 10a and is provided with an active ingredient preparation, comes to rest in front of the steam outlet openings of the applicator. Side regions 20 of the hose 17a rest on the applicator 2 and form the fastening device of the functional element 3.

### LIST OF REFERENCE SIGNS

1 Steam generator

2 Applicator

3 Functional element

4 Reservoir

4a Receiving portion

5 Fastening device

6 Holder

6a First flat element

7 Nozzle

7a Second flat element

8 Lever

8a Hinge

9 Device

9a Through-passage

10 Bellows

10a Carrier element

11 Arrow

12 Flat element

13 Through-passage

14 Steam guide structure

15 Arrow

15a Rubber band

16 Surface

17 Tube connection

17a Tube

18 First end

19 Second end

20 Side region

1. An active ingredient preparation for use in steam generators;
wherein the active ingredient preparation comprises:
A) at least one carrier material selected from
at least one solvent or
at least one water-insoluble powder or granular carrier material selected from silicon dioxide, silicic acids and derivatives thereof, clay, kaolin, bentonite, cellulose, plastics materials, zeolites, diatomaceous earth, or mixtures thereof; and
B) at least one active ingredient selected from
oxygen-based active substances,
easy-ironing components,
insect repellents,
fragrances,
bad odor-control compounds,
antimicrobial agents,
water repellents,
surfactants,
or mixtures thereof.

2. The active ingredient preparation according to claim 1, wherein the at least one carrier material to the at least one active ingredient is present in a weight ratio ranging from 99:1 to 80:15.

3. The active ingredient preparation according to claim 1, wherein one or more of the at least one active ingredient is present in the following amounts:
the oxygen-based substances range from 0 to 10 wt. %; and/or
the easy-ironing components range from 0 to 30 wt. %; and/or
the insect repellants range from 0 to 15 wt. %; and/or
the fragrances range from 0 to 30 wt. %; and/or
the bad odor-control compounds range from 0 to 10 wt. %; and/or
the antimicrobial agents range from 0 to 10 wt. %; and/or
the water repellants range from 0 to 30 wt. %; and/or
the surfactants range from 0 to 50 wt. %;
in each case based on the total weight of the active ingredient preparation.

4. The active ingredient preparation according to claim 1, wherein one or more of the following is present:
(i) the at least one carrier material is a water-insoluble powder or granular carrier material A2 selected from the group consisting of silicon dioxide, silicic acids and derivatives thereof, clay, kaolin, bentonite, cellulose, plastics materials, zeolites, diatomaceous earth, or mixtures thereof;
(ii) the at least one active ingredient comprises at least one fragrance;
(iii) the at least one active ingredient comprises at least one bad odor-control compound; or
(iv) combinations thereof.

5. The active ingredient preparation according to claim 1, wherein one or more of the following is present:
(i) the at least one carrier material is a solvent; and/or
(ii) the at least one active ingredient comprises at least one oxygen-based active substance;
(iii) the at least one active ingredient comprises at least one fragrance;
(iv) the at least one active ingredient comprises at least one bad odor-control compound;
(v) the at least one active ingredient comprises at least one antimicrobial agent;
(vi) the at least one active ingredient comprises at least one surfactant; or
(vii) combinations thereof.

6. A method comprising:
steaming textiles with steam comprising the active ingredient preparation of claim 1.

7. A functional element for a hand-held steam generator for treating textiles, wherein the functional element comprises a carrier element, and wherein the active ingredient preparation according to claim 1 is disposed in or on the carrier element.

8. A method for steaming textiles, wherein the method comprises:
providing a steam generator having the functional element according to claim 7;
generating steam in the steam generator;
bringing the steam into contact with the active ingredient preparation; and
applying applying at least the at least one active ingredient to a textile to be steamed.
